(19) United States
(12) Patent Application Publication
(10) Pub. No.: US 2005/0068859 A1
(43) Pub. Date: Mar. 31, 2005

(54) Focus pull-in apparatus and method thereof

(76) Inventors: Nam-joon Park, Seoul (KR); Dong-ki Hong, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/891,132

(22) Filed: Jul. 15, 2004

(30) Foreign Application Priority Data
Sep. 27, 2003 (KR) 2003-67172

(51) Int. Cl. G11B 7/00

(52) U.S. Cl. 369/44.25; 369/44.34

(57) ABSTRACT

A focus pull-in apparatus and a method thereof are disclosed. The present invention performs the focus pull-in of the optical pickup unit based on the levels of a focus error signal generated when an optical disc rotates, to thereby solve a problem of focus pull-in failure due to the vertical deviation occurring when the optical disc rotates.

### CROSS-REFERENCE TO RELATED APPLICATION

This application claims the benefit under 35 U.S.C. § 119(a) of Korean Patent Application No. 2003-67172, field on Sep. 27, 2003, in the Korean Intellectual Property Office, the entire contents of which is incorporated herein by reference.

### BACKGROUND OF THE INVENTION

1. Field of the Invention

The present invention relates to a focus pull-in apparatus and a method thereof. More particularly, the present invention relates to a focus pull-in apparatus for performing a focus pull-in by taking into account vertical deviation of a disc, and a method thereof.

2. Description of the Related Art

An optical disc recording and reproducing apparatus records data onto an optical disc or reproduces recorded data from an optical disc. An exemplary optical disc recording and reproducing apparatus is a optical pickup unit. The optical pickup unit radiates laser beams onto the surface of an optical disc to record data, or receives laser beams reflected from the surface of an optical disc, so that data can be read for reproduction. To accomplish this, the optical pickup unit requires that laser beams are accurately focused on a data recording layer of an optical disc, focusing is performed by a focus servo.

In the meantime, the optical pickup unit takes the vertical deviation of an optical disc into account in order to focus laser beams onto the data recording surface of the optical disc. The vertical deviation refers to upward and downward movements of the optical disc that occur as the optical disc rotates. Vertical deviation usually occurs due to the flexure of the optical disc. Accordingly, the optical pickup unit moves an objective lens upwards and downwards and determines the time for a focus pull-in by taking the vertical deviation of an optical disc into account, and, when the time for the focus pull-in is determined, the optical pickup unit focuses laser beams onto the data recording surface of the optical disc.

However, if the vertical deviation speed of an optical disc is equal to or larger than an upward and downward movement speed of the objective lens, the focus pull-in of the laser beams is liable to fail. In such circumstances, a conventional optical recording and reproducing apparatus reduces a speed of a spindle motor in order to lower the vertical deviation speed of the optical disc, that is, the rotation speed of the optical disc. The spindle motor rotates the optical disc. Further, the focus pull-in of the laser beams is retried with respect to the optical disc having the lowered rotation speed.

At this time, if the focus pull-in is successfully performed, the conventional optical disc recording and reproducing apparatus increases the speed of the spindle motor, and then records data onto the optical disc or reproduces the recorded data. However, if the focus pull-in fails even after being repeated, the conventional optical disc recording and reproducing apparatus repeats the above operations to retry the focus pull-in. That is, the conventional optical disc recording and reproducing apparatus attempts the focus pull-in several times until the focus pull-in is successfully performed while the speed of the spindle motor is reduced, so that the time it takes to perform the focus pull-in gradually increases. Accordingly, the conventional optical disc recording and reproducing apparatus is inefficient when recording or reproducing data due to focus pull-in failures.

### SUMMARY OF THE INVENTION

Accordingly, it is an aspect of the present invention to provide a focus pull-in apparatus and a method thereof capable of reducing the time for a focus pull-in which increases due to vertical deviation of an optical disc.

In order to achieve the above aspect, an embodiment of the present invention controls a speed of an objective lens while taking into account the vertical deviation of an optical disc as the optical disc rotates.

A generated focus error signal verifies whether vertical deviation of the optical disc occurs. That is, a time for a level of the generated focus error signal to reach a predetermined second reference level from a predetermined first reference level is calculated, and based on the calculated time it is determined whether vertical deviation occurs.

Specifically, the present invention determines whether the vertical deviation occurs, if the calculated time is smaller than a reference time, and outputs a control signal to drive a focusing actuator based on the calculated time.

That is, if the vertical deviation is determined to occur, the focusing actuator drives an objective lens for a predetermined time at a decelerated driving speed. Further, if the predetermined time lapses, an optical pickup unit performs its focus pull-in.

According to another aspect of the present invention, a driving control signal is applied to a focusing drive to drive the focusing actuator, that is, the time at which the decelerated driving speed is applied or the predetermined time for driving the decelerated driving speed are proportional to a difference value between the reference time and the calculated time.

That is, a smaller the calculated time indicates that the objective lens approaches at a relatively rapid speed, and the approach speed is high. In this case, the possibility of servo failure is high if a focus servo is performed without any measurement.

Accordingly, if it is determined that a relative approach speed is high, an embodiment of the present invention applies a driving control signal including a brake signal proportional to the approach speed (inversely proportional to the calculated time since the approach speed is high if the calculated time is small) to the focus drive unit.

Further, the driving control signal applied to the focus drive unit, that is, the driving speed and the predetermined time can vary depending upon a design specification of the focus drive unit, but an appropriate value can be easily obtained by one of ordinary skill in the art through limited repetitive experiments.

### BRIEF DESCRIPTION OF THE DRAWINGS

The invention will be described in detail with reference to the accompanying drawings in which throughout the drawings like reference numerals refer to like elements, and wherein:

FIG. 1 is a diagram illustrating a focus pull-in apparatus according to an embodiment of the present invention;

FIG. 2 is a diagram illustrating a waveform for a focus error signal generated when no vertical deviation occurs on an optical disc;

FIG. 3A is a diagram illustrating a waveform for a focus error signal generated when a loaded optical disc of FIG. 1 rotates;

FIG. 3B is a diagram illustrating a driving control signal applied to a focusing actuator when the focus error signal of FIG. 3A is generated;

FIG. 4 is a flow chart illustrating a focus pull-in method for the focus pull-in apparatus of FIG. 1;

FIG. 5 is a flow chart illustrating a focus pull-in method when the polarity of the focus pull-in apparatus of FIG. 1 is changed; and

FIG. 6A is a diagram illustrating a focus error signal generated in FIG. 5.

FIG. 6B is a diagram illustrating a driving control signal generated in FIG. 5.

### DETAILED DESCRIPTION OF THE PREFERRED EMBODIMENTS

Hereinafter, the embodiments of the present invention will be described in detail with reference to the accompanying drawings.

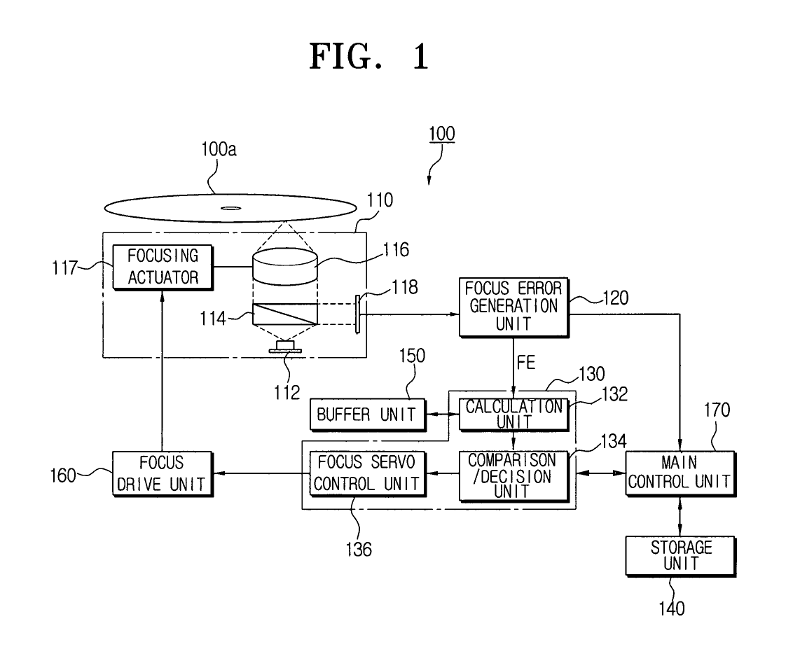

FIG. 1 is a diagram illustrating a focus pull-in apparatus according to an embodiment of the present invention.

Referring to FIG. 1, a focus pull-in apparatus 100 according to an embodiment of the present invention has an optical pickup unit 110, a focus error (FE) generation unit 120, a focus servo processing unit 130, a storage unit 140, a buffer unit 150, a focus drive unit 160, and a main control unit 170.

First, the focus pull-in apparatus 100 shown in FIG. 1 is an apparatus for precisely performing a focus pull-in operation with respect to laser beams onto the surface of an optical disc 100a, and can be provided in an optical recording and reproducing device (not shown). The optical recording and reproducing apparatus (not shown) is an apparatus for recording data onto an optical disc and reproducing recorded data from an optical disc, for which there exist a Digital Video Disk Recorder (DVDR), a personal computer, and so on. Further, the optical discs can be classified into diverse types such as Compact Discs (CDs), Digital Video Discs (DVDs), and so on.

The optical pickup unit 110 outputs data recorded on a information recording surface of the optical disc 100a and converts the output data into an electrical signal. To accomplish this, the optical pickup unit 110 is provided with a light source 112, a beam splitter 114, an objective lens 116, a focusing actuator 117, and a photo detector 118.

The light source 112 radiates laser beams having different waveforms depending upon the type of optical disc 100a that is used. For example, if a DVD is loaded as the optical disc 100a, the light source 112 emits laser beams having a wavelength of about 650 nm.

The beam splitter 114 reflects or passes the laser beams emitted from the light source 112 at a predetermined ratio.

The objective lens 116 focuses the laser beams received from the beam splitter 114 onto the recording surface of the optical disc 100a.

The focusing actuator 117 drives the objective lens 116 upwards and downwards in order for the laser beams received by the optical disc 100a to be precisely focused onto the recording surface of the optical disc 100a. That is, the focusing actuator 117 drives the objective lens 116 upwards and downwards and adjusts a distance between the optical disc 100a and the objective lens 116, to thereby activate a focus servo. The activation of the focus servo indicates the focus pull-in of the optical pickup unit 110.

Performing the focus servo as described above is necessary since the laser beams are precisely focused onto the recording surface of the optical disc 100a in order to reproduce data recorded on the optical disc 100a or to record data.

The photo detector 118 detects the laser beams reflected from the recording surface of the optical disc 100a and converts the detected laser beams into an electrical signal. Photodiode integrated circuits (ICs) are typically used as the photo detector 118.

The focus error (FE) generation unit 120 uses the electric signal output from the photo detector 118 to generate an FE signal for the focus servo, that is, for the focus pull-in. The generated FE signal is provided to the focus servo processing unit 130.

The focus servo processing unit 130 inputs the FE signal from the FE generation unit 120 and processes the input FE signal in order to perform functions such as digital conversions. Further, the focus servo processing unit 130 outputs a driving control signal for driving the focusing actuator 117 based on the processed FE signal. That is, the focus servo processing unit 130 outputs to the focus drive unit 160 the driving control signal to move the objective lens 116 upwards and downwards so that the optical pickup unit 110 forms a focus.

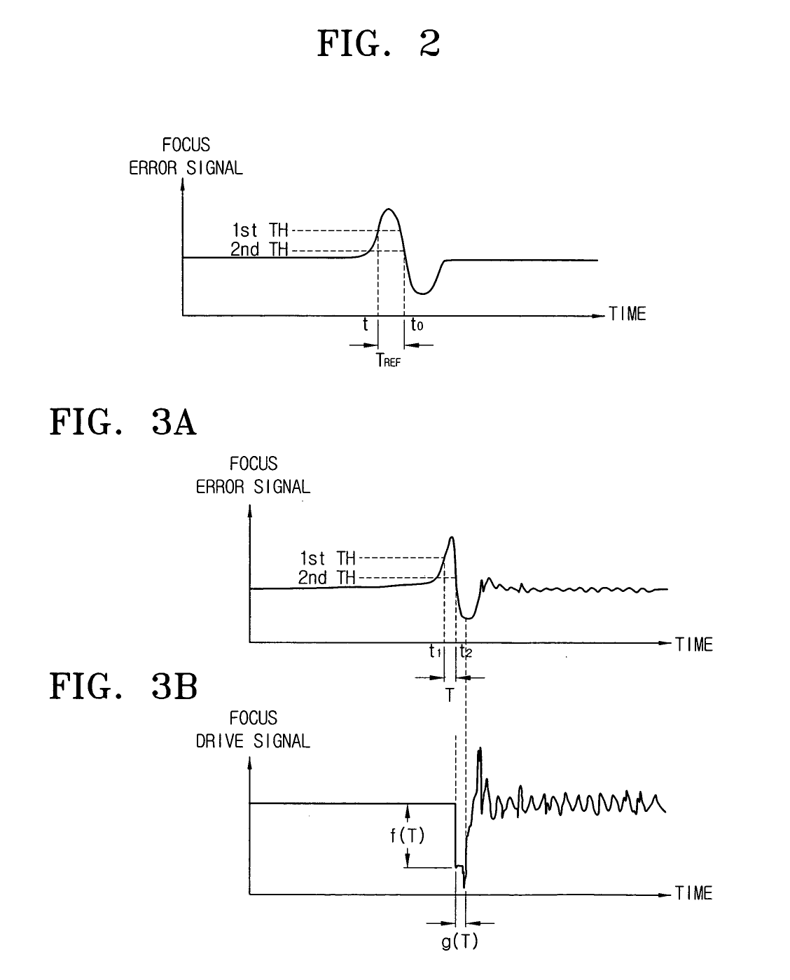

For example, when the objective lens 116 moves upwards and downwards with respect to the optical disc 100a, an FE signal provided from the FE generation unit 120 initially has an S-shaped curve as shown in FIG. 2. The S-shaped curve shown in FIG. 2 is a waveform for an FE signal generated if the optical disc 100a is fixed or the vertical deviation of the optical disc 100a is not generated.

Referring to FIG. 2, the vertical axis indicates the level of a FE signal, and the horizontal axis indicates the duration of time for which the focusing of laser beams moves in a disc direction from its initial position, and a first TH denotes a first reference level, a second TH a second reference level, time t at which the level of the FE signal passes through the first reference level (the first TH), and time t₀ at which the level of the FE signal passes above the second reference level (the second TH).

Further, the first reference level (the first TH) verifies that a provided signal is an FE signal, and the second reference level activates the focusing servo. It is preferable that the first reference level (the first TH) is higher than the second reference level (the second TH).

In an embodiment of the present embodiment, T_{ref} is a reference time it takes for the level of the FE signal to approach the second reference level (the second TH) from the first reference level (the first TH), which is a reference time for a focus pull-in taken when the vertical deviation of the optical disc 100a do not occur. The reference time T_{ref} for the focus pull-in is stored in the storage unit 140 in advance and can be used as a reference for determining whether the vertical deviation occurs. That is, the time measured when focusing can be compared with the reference time for focus pull-in. However, such a reference time T_{ref} for a focus pull-in is not required, and the effect of an embodiment of the present invention can be achieved with a brake signal constantly generated in an inverse proportion to the measured time.

If the level of the FE signal sequentially passes above the predetermined first reference level (the first TH) and the second reference level (the second TH), the focus servo processing unit 130 outputs a driving control signal to activate the focus servo at the time t₀ at which the second reference level (the second TH) passes. The first reference level (the first TH) and the second reference level (the second TH) are established to eliminate the influence of noise, offsets, and so on, that may be in an FE signal.

In an embodiment of the present invention, the focus servo processing unit 130 calculates a certain time for a focus pull-in to be taken until the level of an FE signal reaches the second reference level (the second TH) from the first reference level (the second TH) for more accurate and rapid focus pull-in.

Further, the focus servo processing unit 130 outputs a driving control signal in order for the optical pickup unit 110 to perform its focus pull-in based on the calculated time for the focus pull-in. To accomplish this, the focus servo processing unit 130 is provided with a calculation unit 132, a comparison/decision unit 134, and a focus servo control unit 136.

FIG. 3A is a diagram illustrating a focus error signal generated when the loaded optical disc of FIG. 1 rotates, and FIG. 3B is a diagram illustrating a driving control signal applied to the focusing actuator when the focus error signal is generated as shown in FIG. 3A.

Referring to FIG. 3A, the vertical axis indicates the level of an FE signal, and the horizontal axis indicates the time for which focused laser beams move in the disc direction from its initial position. Further, referring to FIG. 3B, the vertical axis denotes a driving control signal applied to the focus actuator, that is, a focus driving signal, and the horizontal axis denotes the time at which the driving control signal is applied.

If an FE signal having an S-shaped curve as shown in FIG. 3 A is provided from the FE generation unit 120, the calculation unit 132 calculates a predetermined time for a focus pull-in T from the FE signal provided from the FE generation unit 120. That is, a relative approach speed between the optical disc 100a and the objective lens 116 can be calculated.

Specifically, if the level of the FE signal sequentially reaches the first reference level (the first TH) and the second reference level (the second TH), the calculation unit 132 calculates a difference between the first time t₁ at the first reference level (the first TH) and the second time t₂ at the second reference level (the second TH). Further, the calculation unit 132 sets the calculated time difference to the predetermined time for the focus pull-in T.

In order to calculate the time for the focus pull-in T, it is preferable that the times t₁ and t₂ at which the FE signal passes through the first reference level (the first TH) and the second reference level (the second TH), respectively, are stored. Accordingly, the first time t1 and the second time t2 at which the FE signal passes through the first reference level (the first TH) and the second reference level (the second TH) respectively are temporarily stored in the buffer unit 150. The buffer unit 150 can be connected to the main control unit 170 through a bus (not shown).

Further, in addition to the above method, the calculation unit 132 counts the time until the FE signal arrives to the second reference level from the time point of the first reference level (the first TH). Thus, the calculation unit 132 can set the counted time to the time for the focus pull-in T.

The comparison/decision unit 134 compares the magnitudes of the time T for the focus pull-in calculated in the calculation unit 132 and the pre-stored reference time T_{ref} for the focus pull-in. Further, the comparison/decision unit 134 determines whether the vertical deviation occurs on the optical disc 100a which rotates if the time T for the focus pull-in is smaller than the reference time T_{ref} for the focus pull-in.

If the comparison/decision unit 134 determines that the vertical deviation occurs, the focus servo control unit 136 outputs a driving deceleration control signal to drive the focusing actuator 117 for a predetermined time g(T) at a decelerated driving speed f(T). The output driving deceleration control signal is shown in FIG. 3B. That is, if the time T for the focus pull-in is smaller than the reference time T_{ref} for the focus pull-in, the focus servo control unit 136 outputs a brake control signal so that the focusing actuator 117 is driven at the reduced speed f(T). This indicates that the focusing actuator 117 and the optical disc 100a come close at a rapid relative speed due to the vertical deviation of the optical disc 100a if the time T for the focus pull-in is smaller than the reference time T_{ref} for the focus pull-in. That is, if the vertical deviation of the optical disc 100a do not occur, the time T for the focus pull-in is equal to or larger than the reference T_{ref} for the focus pull-in, but the time T for the focus pull-in has a smaller value than the reference T_{ref} for the focus pull-in since the vertical deviation occurs.

Further, if it is determined that the time T for the focus pull-in is smaller than the reference time T_{ref} for the focus pull-in, the focus servo control unit 136 outputs a driving deceleration control signal consisting of the decelerated driving speed f(T) inversely proportional to the time T for the focus pull-in and the predetermined time g(T) inversely proportional to the T. The decelerated driving speed f(T) and the predetermined time g(T) have the relationship as follows:

$$\begin{matrix}f ( T ) ] \frac{1}{T} or f ( T ) ] ( {T}_{ref} - T ) \\ g ( T ) ] \frac{1}{T} or g ( T ) ] ( {T}_{ref} - T )\end{matrix}$$

That is, since the reference time for the focus pull-in T_{ref} is the predetermined time, the decelerated driving speed f(T) and the predetermined time g(T) for which the driving deceleration control signal are applied increase as the time T for the focus pull-in becomes smaller or a value of (T_{ref}−T) becomes larger.

The focus drive unit 160 supplies to the focusing actuator 117 an electric current corresponding to a driving control signal output from the focus servo control unit 136 to drive the focusing actuator 117. Accordingly, the focusing actuator 117 adjusts the objective lens 116 upwards or downwards by a distance in proportion to a current supplied from the focus drive unit 160 so that the optical pickup unit 110 performs its focus pull-in. In an embodiment of the present invention, if the driving deceleration control signal is received from the focus servo control unit 136, the focus drive unit 160 drives the focusing actuator 117 for a predetermined time at a decelerated driving speed corresponding to the driving deceleration control signal.

The main control unit 170 uses various control programs stored in the storage unit 140 to control the overall operations of the focus pull-in apparatus 100. Further, if the focus pull-in control apparatus 100 according to an embodiment of the present invention is provided in an optical recording and reproducing device (not shown), the main control unit 170 can control the overall operation of the optical recording and reproducing device (not shown).

In an embodiment of the present invention, the main control unit 170 controls the focus servo processing unit 130 to adaptively perform a focus servo based on an FE signal generated from the FE generation unit 120.

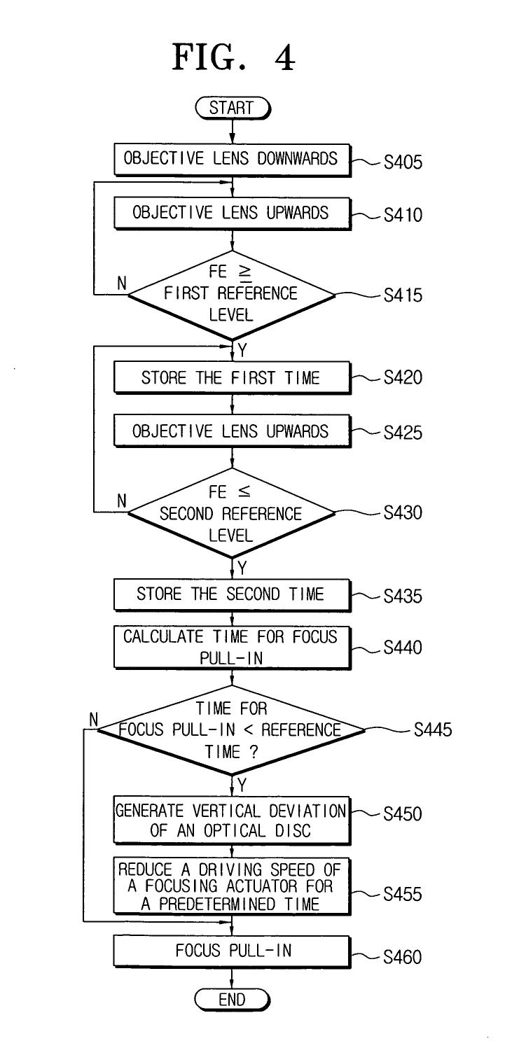

FIG. 4 is a flow chart illustrating a focus pull-in control method based on FIG. 1.

First, the main control unit 170 turns on the light source 112 for focus servo controls of the optical disc 100a, and controls the spindle motor (not shown) to rotate the optical disc 100a. Further, the main control unit 170 forces the optical pickup unit 110 to drive upwards and downwards to generated an FE signal, and identifies the type of optical disc 100a, such as a CD, a DVD, and so on, from the generated FE signal. If the type of optical disc 100a is identified, the focus servo processing unit 130 performs the focus servo, that is, the focus pull-in of the optical pickup unit 110 based on the controls of the main control unit 170.

Referring to FIG. 1 to FIG. 4, a description will be made of a focus pull-in control method as follows. After the type of optical disc 100a is identified, the focus servo control unit 136 outputs a driving control signal in order for the objective lens 116 to go down to the first position at which the FE signal is not detected in step S405. That is, the focusing actuator 117 lowers the objective lens 116 up to the first position by the driving control signal output in step S405. Thus, laser beam spots are not made on the recording surface of the optical disc 100a.

If the objective lens 116 is lowered to the first position, the focus servo control unit 136 outputs a driving control signal to raise the objective lens 116 in step S410. That is, the focusing actuator 117 adjusts the objective lens 116 upwards based on the driving control signal generated in step S410. Thus, a spot of laser beams is made on the recording surface of the optical disc 100a, and the FE signal shown in FIG. 3A is generated from the FE generation unit 120.

If the level of the FE signal output from the FE generation unit 120 reaches the first reference level (the first TH) in step S415, the first time t₁ at which the level of the FE signal reaches the first reference level (the first TH) is temporarily stored in the buffer unit 150 in step S420. Further, the focus servo control unit 136 outputs a driving control signal in order for the objective lens 116 to go upwards until the level of the FE signal reaches the second reference level (the second TH) in step S425. If the level of the FE signal generated from the FE generation unit 120 reaches the second reference level (the second TH) in step S430, the second time t2 at which the level of the FE signal reaches the second reference level (the second TH) is temporarily stored in the buffer unit 150 in step S435.

If step S435 is performed, the calculation unit 132 calculates a difference between the first time t₁ and the second time t₂ in step S440. The calculated time difference is set as a predetermined T for a focus pull-in.

If step S440 is performed, the comparison/decision unit 134 compares the calculated T for the focus pull-in and the pre-stored reference time T_{ref} for the focus pull-in in step S445. That is, if the time T for the focus pull-in is less than the reference T_{ref} for the focus pull-in in step S445, the comparison/decision unit 134 determines that the vertical deviation occurs on the optical disc 100a in step S450.

In step S450, the focus servo control unit 136 outputs a predetermined driving deceleration control signal to the focus drive unit 160 in step S455. By the predetermined driving deceleration control signal output in step S455, the focus drive unit 160 drives the focusing actuator 117 for the predetermined time g(T) at the decelerated driving speed f(T). Further, if the focusing actuator 117 is driven for the predetermined time g(T) at the decelerated driving speed f(T) by the focus drive unit 160, the focus servo control unit 136 drives the optical pickup unit 110 to perform its focus pull-in in step S460.

In step S415, the focus servo control unit 136 outputs a driving control signal for the objective lens 116 to move upwards until the level of the FE signal reaches the first reference level (the first TH). Further, in step S430, the focus servo control unit 136 outputs a driving control signal for the objective lens 116 to move upwards until the level of the FE signal reaches the second reference level(the second TH).

Further, in step S445, if the time T for the focus pull-in is equal to or larger than the reference time T_{ref} for the focus pull-in in step S445, the comparison/decision unit 134 determines that the vertical deviation does not occur on the optical disc 100a, so the focus servo control unit 136 drives the optical pickup unit 110 to perform its focus pull-in in step S460.

The steps S410 to S460 are performed based on the driving control signal generated from the focus servo processing unit 130, and the focus servo processing unit 130 operates based on the controls of the main control unit 170.

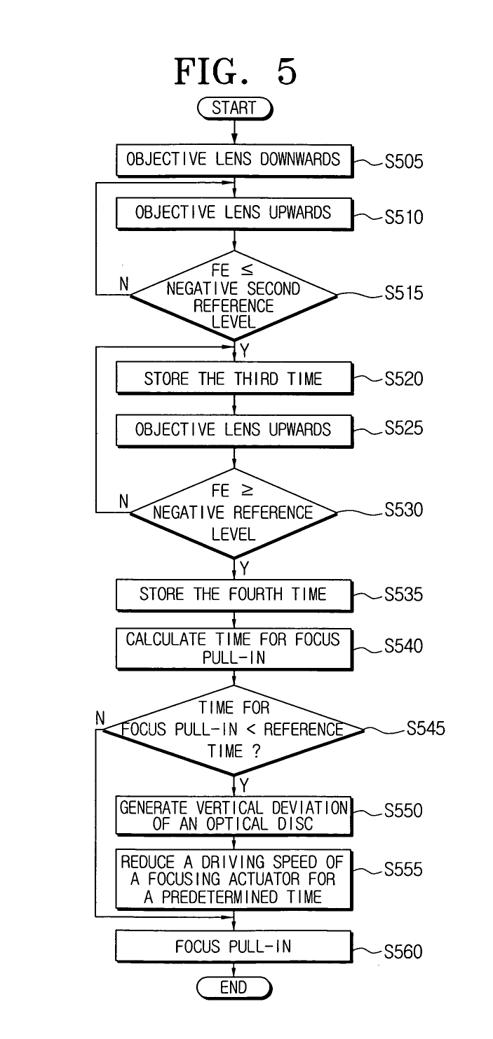

In the focus pull-in apparatus 100 and method according to an embodiment of the present invention, the focus servo processing unit 130 can be implemented to have the opposite polarity, for example. In such an occasion, the focus pull-in method can be explained based on a flow chart shown in FIG. 5.

If the polarity is opposite to FIG. 4, steps S505, S510, S525, and S540 to S560 are similar to steps S405, S410, S425, and S440 to S460, so a detailed description will be omitted.

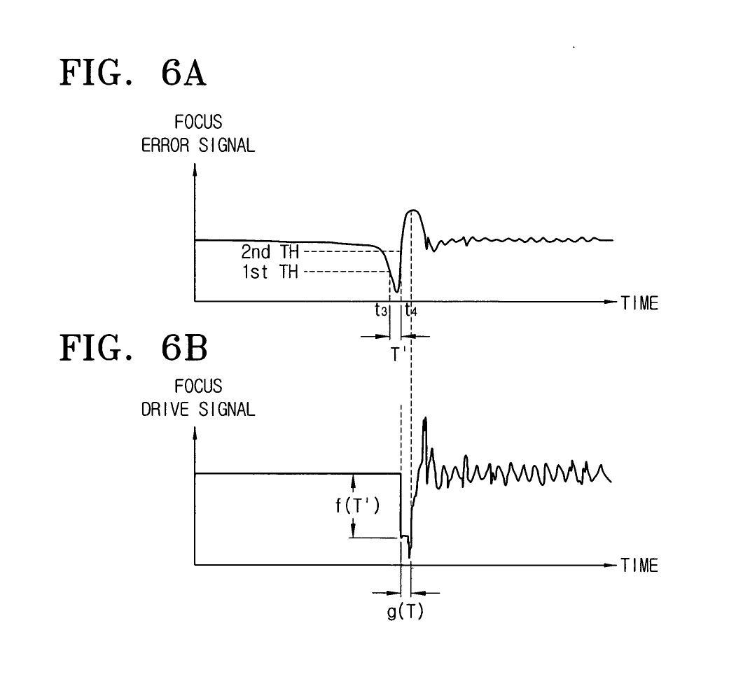

Referring to FIG. 1, FIG. 2, and FIG. 5, the focus servo control unit 136 moves the objective lens 116 downwards to an initial position and then upwards in steps S505 and S510. The FE signal is generated in a waveform shown in FIG. 6 A in step S510. If the level of the FE signal output from the FE generation unit 120 reaches the negative second reference level(the negative second TH) in step S515, the third time t₃ at which the level of the FE signal reaches the negative second reference level(the negative second TH) is temporarily stored in the buffer unit 150 in step S520.

Further, the focus servo control unit 136 outputs a driving control signal for the objective lens 116 to move upwards until the level of the FE signal reaches the negative first reference level (the negative first TH) in step S525. If the level of the FE signal reaches the negative first reference level (the negative first TH) in step S530, the fourth time t4 at which the level of the FE signal reaches the negative first reference level (the negative first TH) is temporarily stored in the buffer unit 150 in step S535.

If step S535 is performed, the calculation unit 132 outputs a difference between the third time t₃ and the fourth time t₄ in step S540. The calculated time difference is set as a predetermined time T′ for a focus pull-in. Further, the focus servo control unit 136 compares the time T′ for the focus pull-in and the reference time T_{ref} for focus pull-in to determine whether the vertical deviation occurs in step S545. If the vertical deviation occurs in step S550, driving deceleration control signals f(T′) and g(T′) corresponding to the time T′ for the focus pull-in are output as shown in FIG. 6B in step S555. Thus, the optical pickup unit 110 performs its focus pull-in after the predetermined time g(T′) in step S560.

Accordingly, the focus pull-in apparatus 100 and method described with reference to FIG. 1 to FIG. 6 perform the focus pull-in of the optical pickup unit based on the levels of a focus error signal generated when an optical disc rotates, to thereby quickly solve the problem of focus pull-in failure due to the vertical deviation occurring when the optical disc rotates.

As described, the focus pull-in apparatus and method according to embodiments of the present invention can more precisely determine when the optical pickup unit performs its focus pull-in with respect to the optical disc having vertical deviation, to thereby perform a focus servo in a short time.

Although the certain embodiments of the present invention have been described, it should be understood by those skilled in the art that the present invention should not be limited to the described embodiments, but various changes and modifications can be made within the spirit and scope of the present invention as defined by the appended claims.

1. A focus pull-in apparatus for focusing beams onto an information recording surface of an optical disc, comprising:
an optical pickup unit having a light source for emitting the beams, an objective lens for focusing the beams onto the information recording surface, a focusing actuator for moving the objective lens in a light axis direction, and a photo detector for detecting beams reflecting from the optical disc and converting the detected beams into an electrical signal; and
a control unit for generating a focus error signal from an output signal of the photo detector, when a focus search is performed as the objective lens moves in order for the beams to move across the optical disc, calculating a relative approach speed between the information recording surface and the objective lens based on the generated focus error signal, and driving the focusing actuator based on the approach speed and controlling the approach speed of the objective lens.

2. The focus pull-in control apparatus as claimed in claim 1, wherein the approach speed is calculated based on a time for which a level of the focus error signal reaches a predetermined second level from a predetermined first level.

3. The focus pull-in apparatus as claimed in claim 2, wherein the first level and the second level are set to correspond to two points on a parabola portion first appearing in an S-shaped curve of the focus error signal.

4. The focus pull-in apparatus as claimed in claim 3, wherein an absolute value of the first level is set to be equal to or larger than an absolute value of the second level.

5. The focus pull-in apparatus as claimed in any of claim 2, wherein the control unit supplies to the actuator a brake signal inversely proportional to the time.

6. The focus pull-in apparatus as claimed in claim 5, wherein the brake signal has at least one of a magnitude and an applying time that are inversely proportional to the time.

7. A focus pull-in method, comprising the steps of:
performing a focus search as the objective lens moves in order for the beams to move across the optical disc;
generating a focus error signal from an output signal of a photo detector during the focus search performance;
calculating a relative approach speed between an information recording surface of the optical disc and the objective lens from the focus error signal; and
driving a focusing actuator according to the approach speed and controlling an approach speed of the objective lens.

8. The focus pull-in method as claimed in claim 7, wherein the approach speed calculation step calculates the approach speed based on a time for which a level of the focus error signal reaches a predetermined second level from a predetermined first level.

9. The focus pull-in method as claimed in claim 8, wherein the first level and the second level are set to correspond to two points on a parabola portion first appearing in an S-shaped curve of the focus error signal.

10. The focus pull-in method as claimed in claim 9, wherein an absolute value of the first level is set to be equal to or larger than an absolute value of the second level.

11. The focus pull-in method as claimed in any of claim 8, wherein the approach speed control unit supplies to the actuator a brake signal inversely proportional to the time to reduce the approach speed of the objective lens.

12. The focus pull-in method as claimed in claim 11, wherein the brake signal has at least one of a magnitude and an applying time that are inversely proportional to the time.
